(19) United States
(12) Patent Application Publication
(10) Pub. No.: US 2020/0298744 A1
(43) Pub. Date: Sep. 24, 2020

(54) LIGHT GUARD FOR A VEHICLE LIGHT

(71) Applicant: Richard Rowe, Farmers Branch, TX (US)

(72) Inventor: Richard Rowe, Farmers Branch, TX (US)

(21) Appl. No.: 16/357,319

(22) Filed: Mar. 18, 2019

(51) Int. Cl. B60Q 1/00; B60Q 1/04; F21S 45/10

(52) U.S. Cl. CPC B60Q 1/0005; F21W 2102/00; F21S 45/10; B60Q 1/04

(57) ABSTRACT

A light guard for a vehicle light having an outer perimeter and including: a frame portion and a mesh portion, the frame portion comprising a flat rigid frame sized and shaped to fit the outer perimeter of a particular vehicle light; the mesh portion comprising a rigid mesh sized sufficiently small to prevent penetration of stones and road debris, but sufficiently large to allow passage of light from the vehicle light; the mesh portion being attached around its perimeter to the frame portion; the frame portion having at least one fastener to secure the light guard to the vehicle light; whereby, the mesh portion of the light guard covers the particular light protecting it from damage from stones and road debris.

### FIELD OF THE INVENTION

This invention relates to vehicle accessories. More particularly, it relates to protective guards for vehicle lighting systems.

### BACKGROUND

Headlight covers are aftermarket modifications made from a variety of materials (e.g., metal, polycarbonate, ABS plastic or self-adhesive vinyl film) which are applied over the headlamps of a new or used car in order to reduce the percentage of light transmitted, to tint the color of the light transmitted and/or to protect the lenses from stone chips, bug splatters, pedestrians and minor abrasions.

The use of headlight covers and the modification of light produced by vehicles has continued into the present day in both the military's development of special blackout head and tail light technologies and in the civilian sector as well. In addition to headlight covers' use in light reduction they have also been employed to protect headlamps from damage in both civilian and combat environments.

Many of the current items available on the market for protecting vehicle lights (both front and rear) tend to blur or at least reduce the amount of light displayed from the vehicle. This is not always beneficial or even desired by the user. In many cases, a loss of headlight or taillight integrity can become problematic and even unsafe. In addition, many of the items currently on the market rely on special films or plastic coverings that can become scratched, cracked or even broken when struck by loose impediments on roadways or trails. A suitable solution is desired.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front elevation environmental view of certain elements of the vehicle light guard set 5 installed on a vehicle 100, according to the preferred embodiment of the present invention;

FIG. 2 is a rear elevation environmental view of certain elements of the vehicle light guard set 5 installed on a vehicle 100, according to the preferred embodiment of the present invention;

FIG. 3 is another front elevation environmental view of certain elements of the vehicle light guard set 5 installed on a vehicle 100, according to the preferred embodiment of the present invention;

FIG. 4 is another rear elevation environmental view of certain elements of the vehicle light guard set 5 installed on a vehicle 100, according to the preferred embodiment of the present invention;

FIG. 5a is a front view of a first head light guard 10a, according to the preferred embodiment of the present invention;

FIG. 5b is a front view of a second head light guard 10b, according to the preferred embodiment of the present invention;

FIG. 5c is a rear view of the first head light guard 10a, according to the preferred embodiment of the present invention;

FIG. 5d is a rear view of the second head light guard 10b, according to the preferred embodiment of the present invention;

FIG. 5e is a top view of the first head light guard 10a, according to the preferred embodiment of the present invention;

FIG. 5f is a top view of the second head light guard 10b, according to the preferred embodiment of the present invention;

FIG. 6a is a front view of a first fog light guard 20a, according to the preferred embodiment of the present invention;

FIG. 6b is a front view of a second fog light guard 20b, according to the preferred embodiment of the present invention;

FIG. 6c is a rear view of the first fog light guard 20a, according to the preferred embodiment of the present invention;

FIG. 6d is a rear view of the second fog light guard 20b, according to the preferred embodiment of the present invention;

FIG. 6e is a top view of the first fog light guard 20a, according to the preferred embodiment of the present invention;

FIG. 6f is a top view of the second fog light guard 20b, according to the preferred embodiment of the present invention;

FIG. 7a is a front view of a first tail light guard 30a, according to the preferred embodiment of the present invention;

FIG. 7b is a front view of a second tail light guard 30b, according to the preferred embodiment of the present invention;

FIG. 7c is a rear view of the first tail light guard 30a, according to the preferred embodiment of the present invention;

FIG. 7d is a rear view of the second tail light guard 30b, according to the preferred embodiment of the present invention;

FIG. 7e is a top view of the first tail light guard 30a, according to the preferred embodiment of the present invention; and,

FIG. 7f is a top view of the second tail light guard 30b, according to the preferred embodiment of the present invention.

### DESCRIPTIVE KEY

5 vehicle light guard set

10a first head light guard

10b second head light guard

11 head light guard fastener

15 head light guard border

18a first head light guard removable fastener

18b second head light guard removable fastener

20a first fog light guard

20b second fog light guard

21 fog light guard fastener

25 fog light guard border

28a first fog light guard removable fastener

28b second fog light guard removable fastener

30a first tail light guard

30b second tail light guard

31 tail light guard fastener

35 tail light guard border

38a first tail light guard removable fastener

38b second tail light guard removable fastener

100 vehicle

101a first head light

101b second head light

102a first fog light

102b second fog light

103a first tail light

103b second tail light

### DESCRIPTION OF THE PREFERRED EMBODIMENTS

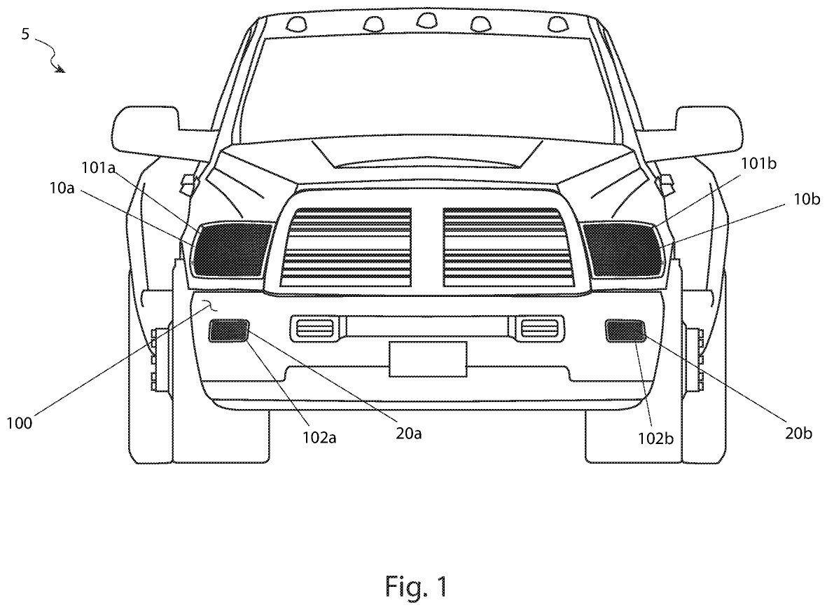

The best mode for carrying out the invention is presented in terms of its preferred embodiment, herein depicted within FIGS. 1 through 7f. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims. The terms “a” and “an” herein do not denote a limitation of quantity, but rather denote the presence of at least one (1) of the referenced items.

### 1. Detailed Description of the Figures

Referring now to FIGS. 1 through 4, are various environmental views of the certain elements of the vehicle light guard set (herein described as the “set”) 5, according to a preferred embodiment of the present invention. It is shown in the figures that a typical vehicle 100 has a first head light 101a (herein illustrated as the passenger side), a second head light 101b (herein illustrated as the driver side), a first fog light 102a (herein illustrated as the passenger side), a second fog light 102b (herein illustrated as the driver side), a first tail light 103a (herein illustrated as the passenger side), and a second tail light 103b (herein illustrated as the driver side). The vehicle 100 represented herein is illustrated as a Dodge Ram (4th generation) truck, but it is understood that the set 5 can be configured to accommodate the geometries of the head lights 101a, 10b, fog lights 102a, 102b, and tail lights 103a, 103b for any particular vehicle 100 and fall under the overall scope of the present teachings. The guards 10a, 10b, 20a, 20b, 30a, 30c of the set 5 are capable of protecting the respective light element 101a, 101b, 102a, 102b, 103a, 103c of the vehicle 100 upon which it is removably attached. The protection is typically from unauthorized tampering or destruction, or normal wear and tear during operation or resting of the vehicle 100 from debris.

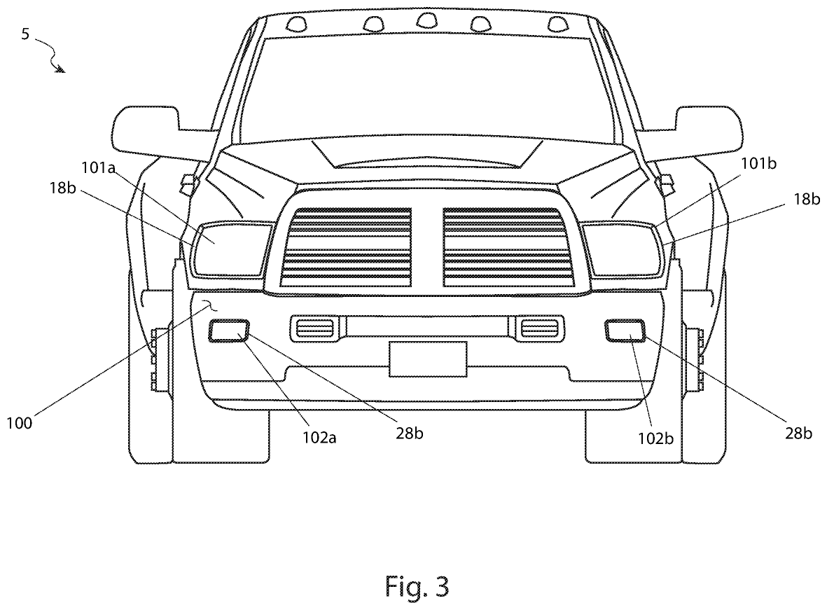

As illustrated in FIG. 1, the set 5 comprises a first head light guard 10a that is removably attached around the first head light 101a and has an overall shape and size that conforms to the outer geometry thereof. Similarly, the set 5 further comprises a second head light guard 10b that is removably attached around the second head light 101b and has an overall shape and size that conforms to the outer geometry thereof. Referring more closely to FIG. 3, it can be shown that a second head light guard removable fastener 18b is configured to be removably attached about the perimeter of the first head light 101a and another second head light guard removable fastener 18b is configured to be removably attached about the perimeter of the second head light 101b. In a preferred embodiment, the second head light guard removable fasteners 18b are one-half (½) of a complementary type of fastener set, such as a hook-and-loop style of fastener (e.g. Velcron™).

Also referring to FIG. 1, the set 5 further comprises a first fog light guard 20athat is removably attached around the first fog light 102a and has an overall shape and size that conforms to the outer geometry thereof. Similarly, the set 5 further comprises a second fog light guard 20b that is removably attached around the second fog light 102b and has an overall shape and size that conforms to the outer geometry thereof. Referring more closely to FIG. 3, it can be shown that a second fog light guard removable fastener 28b is configured to be removably attached about the perimeter of the first fog light 102a and another second fog light guard removable fastener 28b is configured to be removably attached about the perimeter of the second fog light 102b. In a preferred embodiment, the second fog light guard removable fasteners 28b also are one-half (½) of a complementary type of fastener set, such as a hook-and-loop style of fastener (e.g. Velcron™).

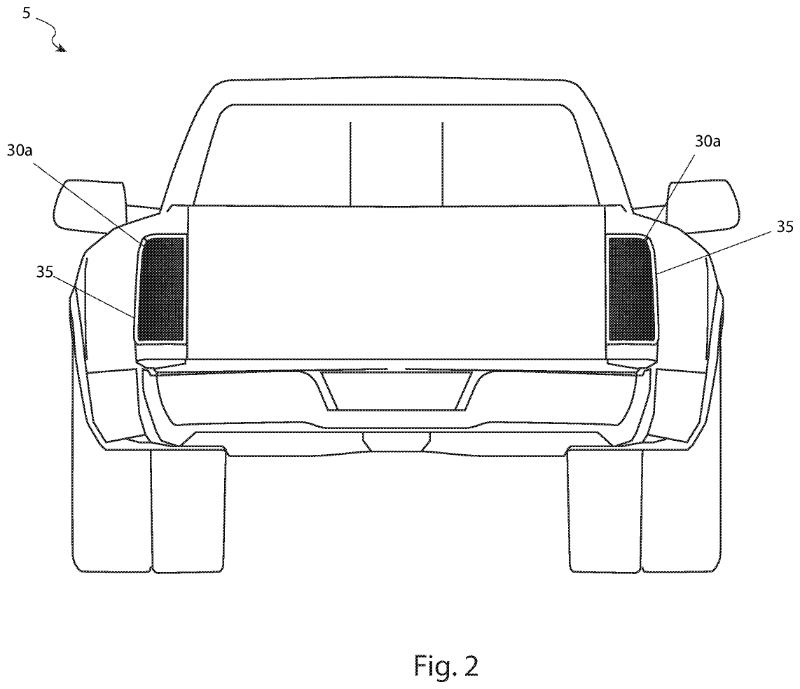

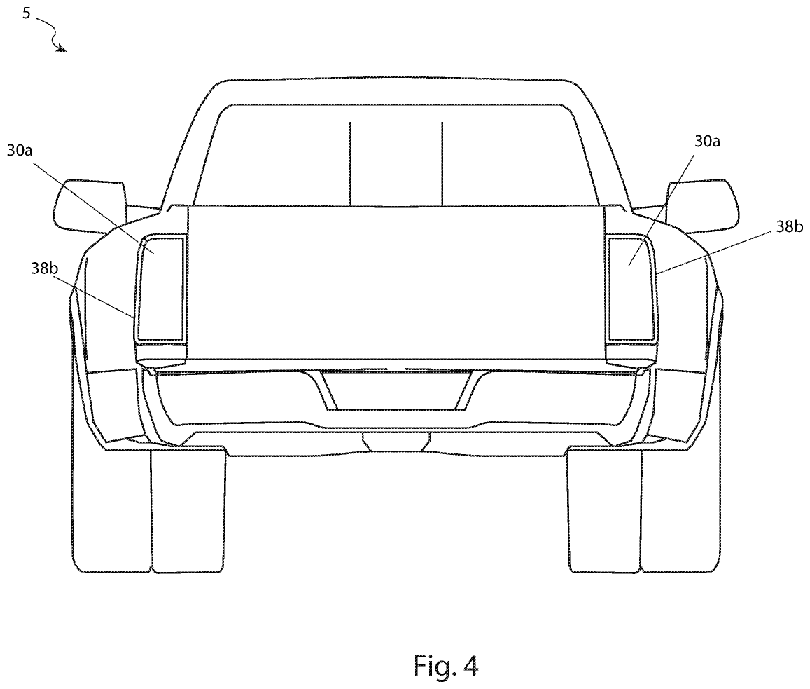

Referring now to FIG. 2, the set 5 also comprises a first tail light guard 30athat is removably attached around the first tail light 103a and has an overall shape and size that conforms to the outer geometry thereof. Similarly, the set 5 further comprises a second tail light guard 30b that is removably attached around the second tail light 103b and has an overall shape and size that conforms to the outer geometry thereof. Referring more closely to FIG. 4, it can be shown that a second tail light guard removable fastener 38b is configured to be removably attached about the perimeter of the first tail light 103a and another second tail light guard removable fastener 38b is configured to be removably attached about the perimeter of the second tail light 103b. In a preferred embodiment, the second tail light guard removable fasteners 38b also are one-half (½) of a complementary type of fastener set, such as a hook-and-loop style of fastener (e.g. Velcron™).

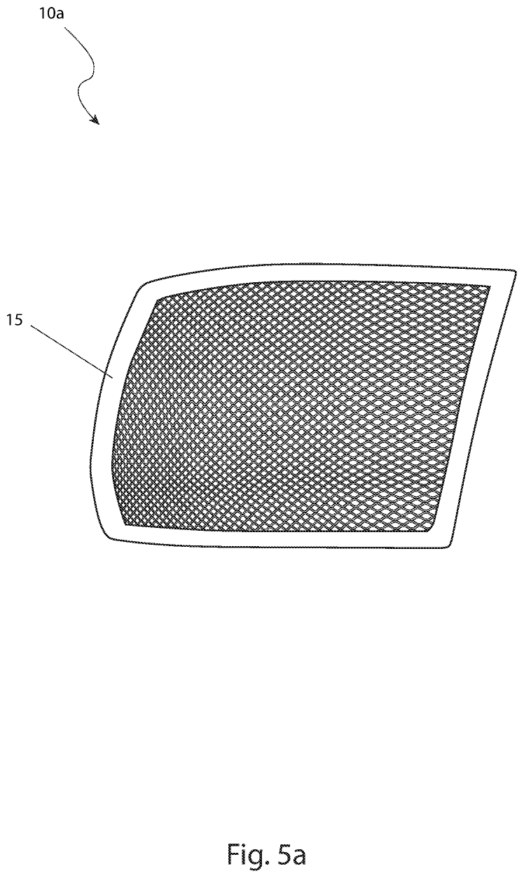

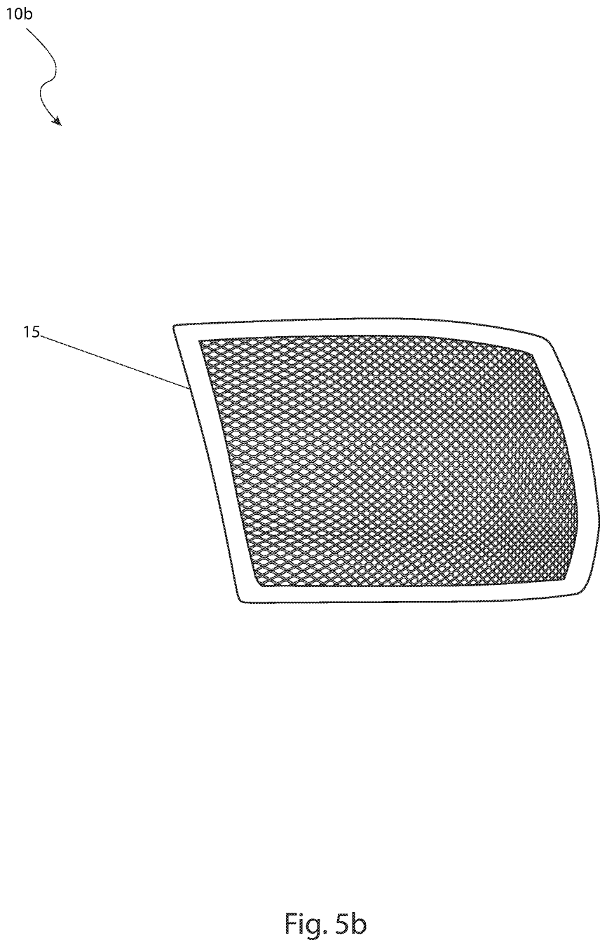

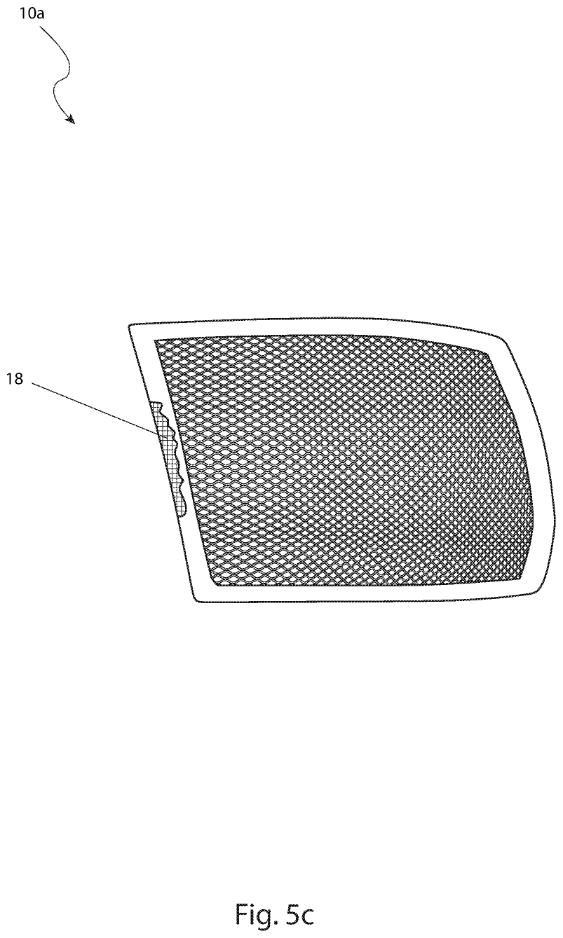

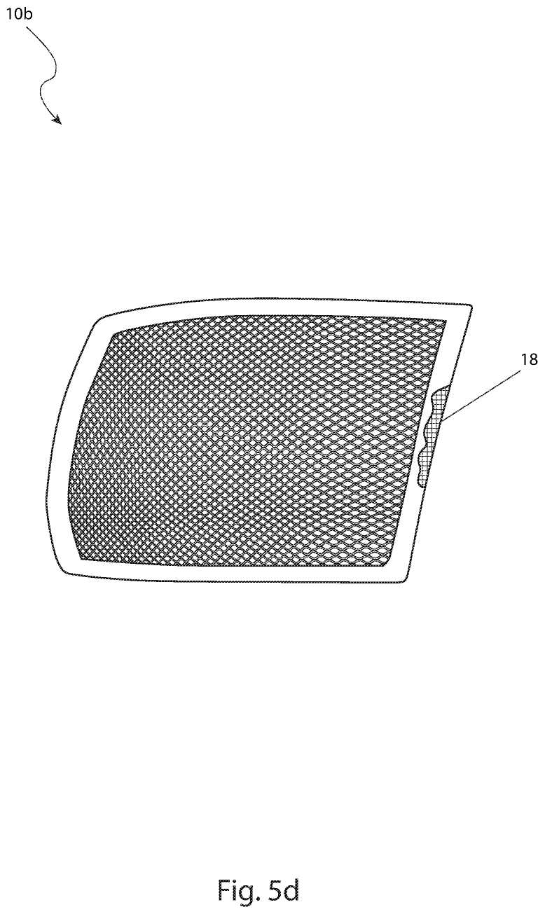

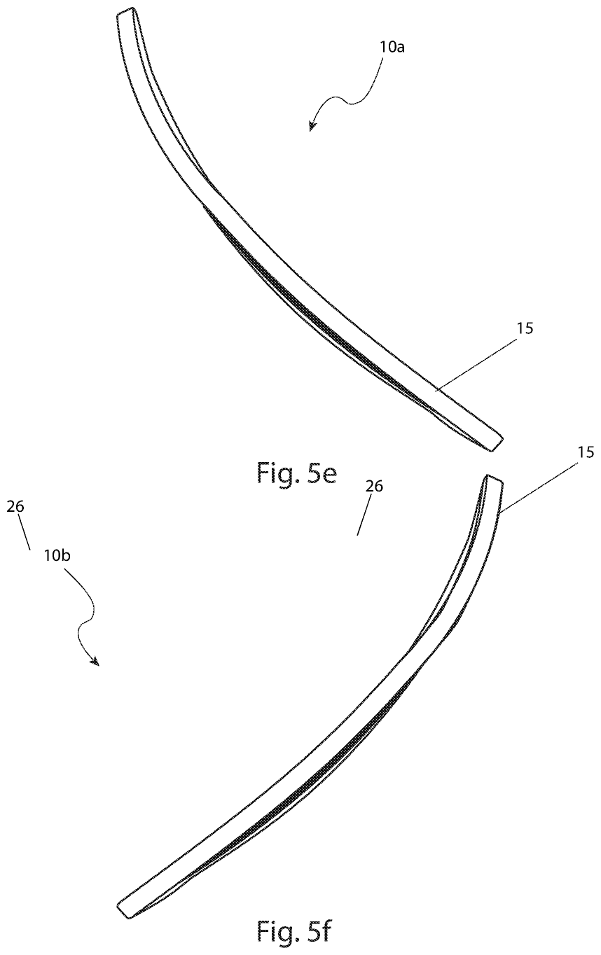

Referring now to FIGS. 5a-5f, various views of the first head light guard 10aand second head light guard 10b, are herein described. As previously mentioned, the first head light guard 10a and second head light guard 10b are each shaped and sized to conform to the overall outer geometry of the first head light 101a and second head light 101b, respectively, of a vehicle 100 that the set 5 is to be attached. Each head light guard 10a, 10b is comprised of a resilient mesh, preferably in a diamond configuration, that is capable of enabling light to pass through generated by the respective head light 101a, 101b, but of a configuration to protect small, medium, and large pieces of debris from contacting, marring, or breaking the said head light 101a, 101b. The material is most preferably a stainless steel fabrication to resist corrosion and other environmental impact and is shaped and sized to fully cover the head lights 101a, 101b of the vehicle 100. An exemplary embodiment provides for protecting the head lights 101a, 101b on a vehicle 100 such as a Dodge Ram 4^{th} generation truck, wherein dimensions include a height of nine inches (9 in.) on an inside edge, a lower height of three and three-quarters inches (3-¾in.) and an upper height of eight inches on an outer edge, a length of sixteen inches (16 in.) at the upper edge, and a length of seventeen and one-half inches (17-½in.) at a lower edge. The thickness is approximately one-half inch (½in.).

Each head light guard 10a, 10b comprises a front side and a rear side. The rear side of each is configured to mate with the respective second head light guard removable fastener 18b via a first head light guard removable fastener 18a. A head light guard border 15 is conformably attached to the perimeter of the front side of each head light guard 10a, 10b and has a length enabling full circumscribing thereof. The first head light guard removable fastener 18a is removably attached to the outer perimeter of the rear side of the head light guard border 15 and is preferably one-half (½) of a complementary type of fastener set, such as a hook-and-loop style of fastener (e.g. Velcro™), capable of mating with the second head light guard removable fastener 18b. In certain embodiments, the front side of the head light guard border 15 comprises a deformable cushioning material to deflect and provide further protection during an impact force.

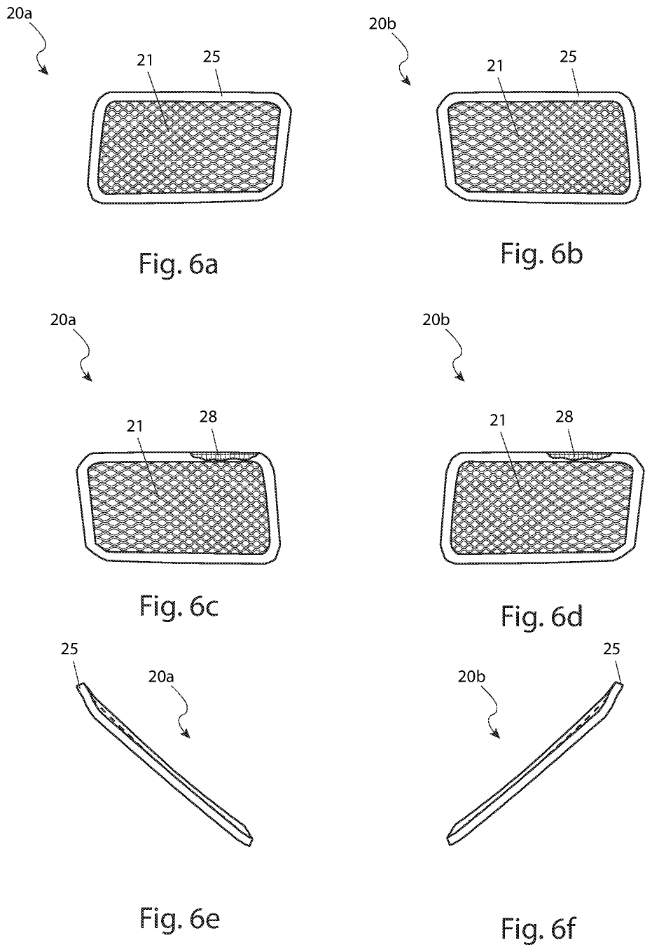

Referring now to FIGS. 6a-6f, various views of the first fog light guard 20a and second fog light guard 20b, are herein described. As previously mentioned, the first fog light guard 20a and second fog light guard 20b are each shaped and sized to conform to the overall outer geometry of the first fog light 102a and second fog light 102b, respectively, of a vehicle 100 that the set 5 is to be attached. Each fog light guard 20a, 20b is comprised of a resilient mesh, preferably in a diamond configuration, that is capable of enabling light to pass through generated by the respective fog light 102a, 102b, but of a configuration to protect small, medium, and large pieces of debris from contacting, marring, or breaking the said fog light 102a, 102b. The material is most preferably a stainless steel fabrication to resist corrosion and other environmental impact and is shaped and sized to fully cover the fog lights 102a, 102b of the vehicle 100. An exemplary embodiment provides for protecting the fog lights 102a, 102b on a vehicle 100 such as a Dodge Ram 4^{th} generation truck, wherein dimensions include a height of three and one-eighths inches (3-⅛in.) on both inside and outside edges, and a length of seven and three-quarters inches (3-¾in.) at both the upper and lower edges. The thickness is approximately one-half inch (½in.).

Each fog light guard 20a, 20b comprises a front side and a rear side. The rear side of each is configured to mate with the respective second fog light guard removable fastener 28b via a first fog light guard removable fastener 28a. A fog light guard border 25 is conformably attached to the perimeter of each fog light guard 20a, 20b and has a length enabling full circumscribing thereof. The first fog light guard removable fastener 28a is removably attached to the outer perimeter of the rear side of the fog light border guard 25 and is preferably one-half (½) of a complementary type of fastener set, such as a hook-and-loop style of fastener (e.g. Velcro™), capable of mating with the second fog light guard removable fastener 28b. In certain embodiments, the front side of the fog light guard border 25 comprises a deformable cushioning material to deflect and provide further protection during an impact force.

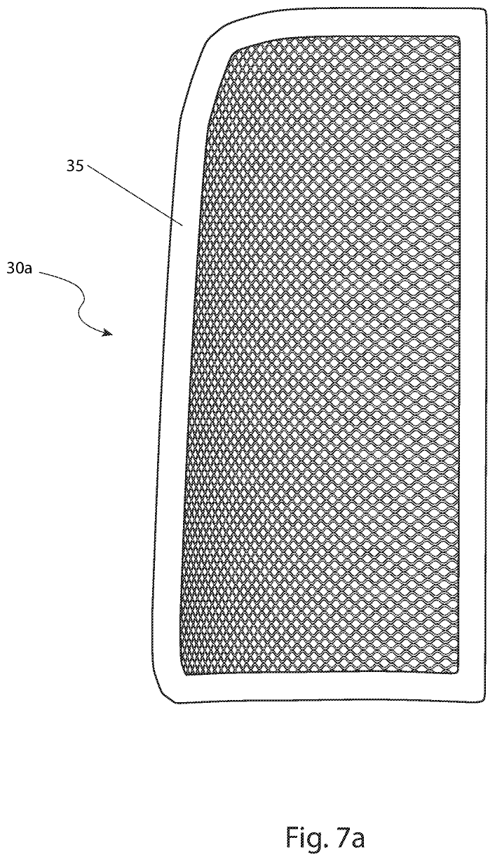

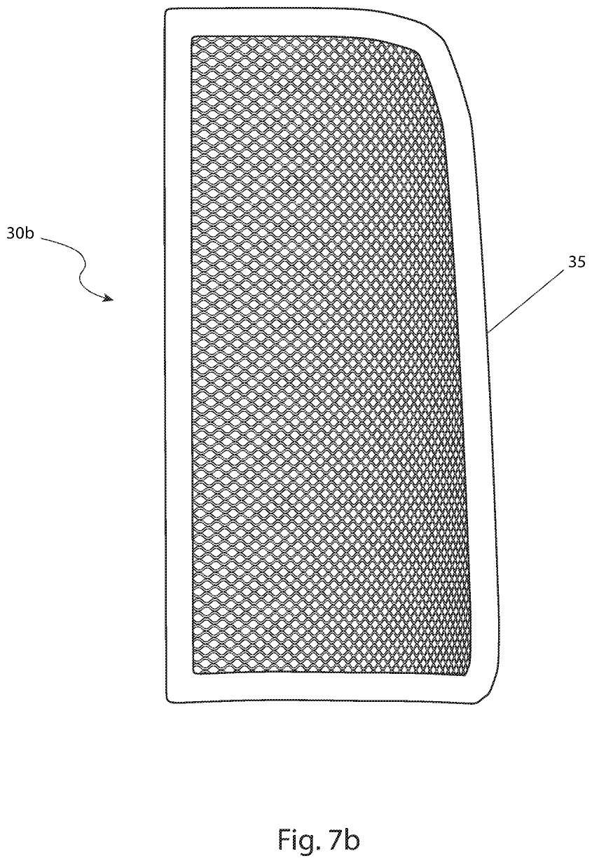

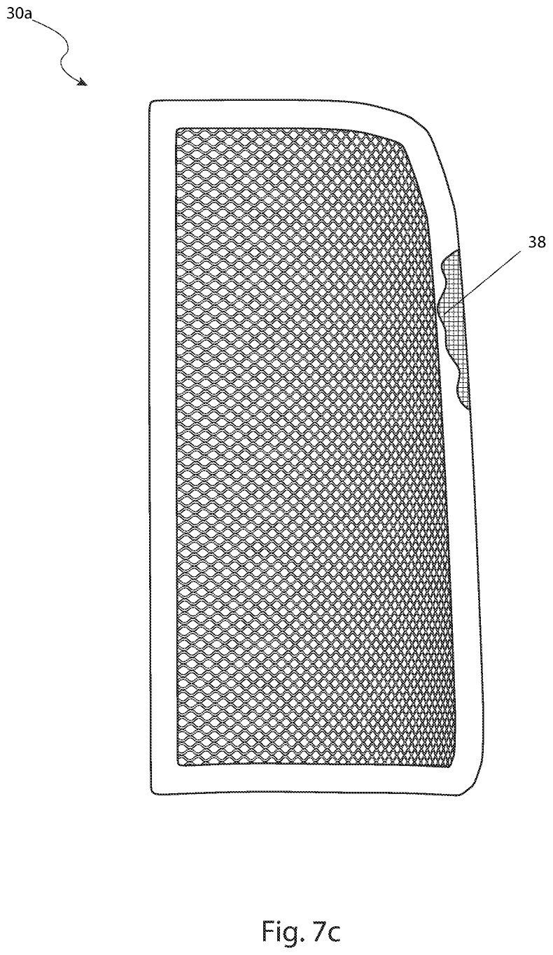

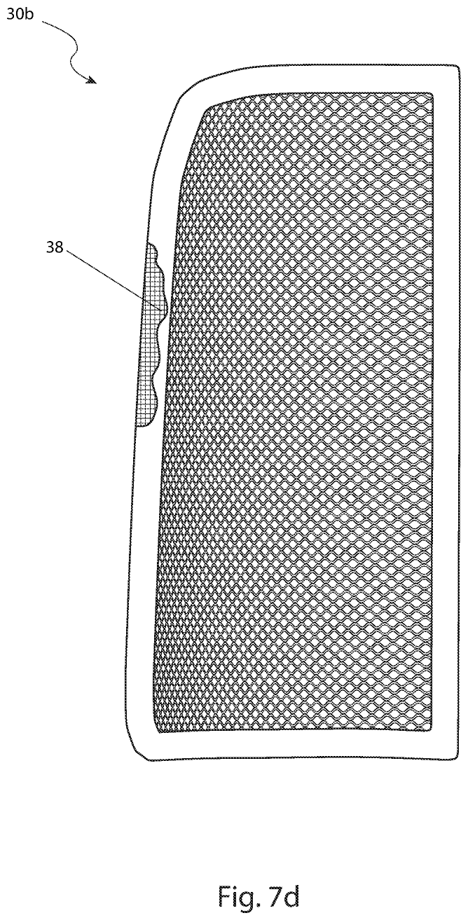

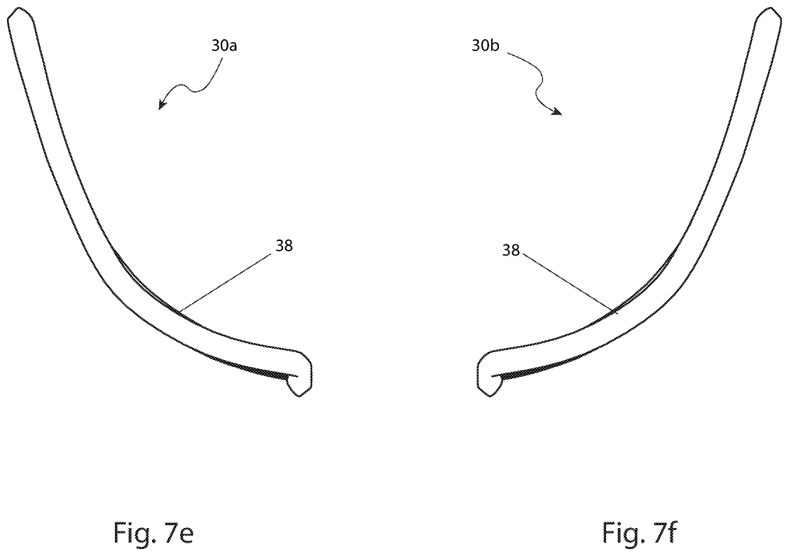

Referring now to FIGS. 7a-7f, various views of the first tail light guard 30a and second tail light guard 30b, are herein described. As previously mentioned, the first tail light guard 30a and second tail light guard 30b are each shaped and sized to conform to the overall outer geometry of the first tail light 103a and second tail light 103b, respectively, of a vehicle 100 that the set 5 is to be attached. Each tail light guard 30a, 30b is comprised of a resilient mesh, preferably in a diamond configuration, that is capable of enabling light to pass through generated by the respective tail light 103a, 103b, but of a configuration to protect small, medium, and large pieces of debris from contacting, marring, or breaking the said tail light 103a, 103b. The material is most preferably a stainless steel fabrication to resist corrosion and other environmental impact and is shaped and sized to fully cover the tail lights 103a, 103b of the vehicle 100. An exemplary embodiment provides for protecting the tail lights 103a, 103b on a vehicle 100 such as a Dodge Ram 4th generation truck, wherein dimensions include a height of thirteen inches (13 in.) on the inside edge, a height of fourteen inches (14 in.) on an outside edge, a length of ten inches (10 in.) on an upper edge, and a length of twelve and three-quarters inches (12-¾in.) on a lower edge. The thickness is approximately one-half inch (½in.).

Each tail light guard 30a, 30b comprises a front side and a rear side. The rear side of each is configured to mate with the respective second tail light guard removable fastener 38b via a first tail light guard removable fastener 38a. A tail light guard border 35 is conformably attached to the perimeter of each tail light guard 30a, 30b and has a length enabling full circumscribing thereof. The first tail light guard removable fastener 38a is removably attached to the outer perimeter of the rear side of the tail light guard border 35 and is preferably one-half (½) of a complementary type of fastener set, such as a hook-and-loop style of fastener (e.g. Velcro™), capable of mating with the second tail light guard removable fastener 38b. In certain embodiments, the front side of the tail light guard border 35 comprises a deformable cushioning material to deflect and provide further protection during an impact force.

### 2. Operation of the Preferred Embodiment

The preferred embodiment of the present invention can be utilized by the common user in a simple and effortless manner with little or no training. It is envisioned that the set 5 would be constructed in general accordance within FIGS. 1 through 4. The user would procure the set 5 through normal procurement channels typically used to purchase automotive aftermarket items. The set 5 may be provided as an integral component to newly purchased vehicles 100. Special attention would be paid to make and model of the vehicle 100 which would correspond to the accompanying set 5 that is required to properly fit and protect the head lights 101a, 101b, fog lights 102a, 102b, and tail lights 103a, 103b.

To apply the set 5 to the vehicle 100, the area around the desired light element 101a, 101b, 102a, 102b, 103a, 103b is to be cleaned from any dirt and debris, prior to attachment of the respective second light guard removable fastener 18b, 28b, 38b. The respective light guard border 15, 25, 35 is then obtained and shaped to fit about the perimeter of the respective light guard 10a, 10b, 20a, 20b, 30a, 30b. The respective first light guard removable fastener 18a, 28a, 38a is then removably attached about the perimeter of the second side of the light guard 10a, 10b, 20a, 20b, 30a, 30b. Finally, the respective light guard 10a, 10b, 20a, 20b, 30a, 30b is removably attached about the respective light element 101a, 101b, 102a, 102b, 103a, 103b by mating the respective first light guard removable fasteners 18a, 28a, 38a to the respective second light guard removable fasteners 18b, 28b, 38b.

In certain embodiments, the set 5 may come with the fastener sets (i.e., 18a and 18b, 28a and 28b, 38a and 38b ) already pre-fastened, with the adhesive portion of the rear of the respective second light guard removable fasteners 18b, 28b, 38b covered with a peel-away backing. To install, the user removes the backing from the respective second light guard removable fasteners 18b, 28b, 38b and places the entire respective light guard 10a, 10b, 20a, 20b, 30a, 30b around the respective light element 101a, 101b, 102a, 102b, 103a, 103b.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A light guard for a vehicle light, the vehicle light having an outer perimeter, the light guard consisting of:
a frame portion and a mesh portion, the frame portion comprising a flat rigid frame sized and shaped to fit the outer perimeter of a particular vehicle light; the mesh portion comprising a rigid mesh sized sufficiently small to prevent penetration of stones and road debris, but sufficiently large to allow passage of light from the vehicle light;
the mesh portion being attached around a perimeter of the light guard to the frame portion; the frame portion having at least one fastener to secure the light guard to the vehicle light; and
whereby, the mesh portion of the light guard covers the particular light protecting it from damage from stones and road debris.

2. The light guard of claim 1 wherein the mesh portion is stainless steel.

3. The light guard of claim 1 wherein the mesh portion comprises a diamond-shaped mesh pattern.

4. The light guard of claim 1 wherein the fastener comprises hook and loop material.

5. The light guard of claim 4 wherein the hook and loop material extends around the outer perimeter of the vehicle light.

6. The light guard of claim 1 further comprising a plurality of fasteners.

7. The light guard of claim 1 wherein the frame portion, with the mesh portion attached, has a thickness of approximately one-half inch.

8. The light guard of claim 1 sized and shaped to fit a light on the particular vehicle chosen from the group consisting of head light, tail light, parking light and fog light.

9. The light guard of claim 8 used in multiple copies to cover the head lights, tail lights, parking lights and fog lights of the particular vehicle.

10. A system of light guards for protecting the lights of a particular vehicle, the system consisting of:
a plurality of lights, each light having an outer parameter, including a light guard for at least each light and each tail light of the particular vehicle, wherein each of the light guards includes: a frame portion and a mesh portion, the frame portion comprising a flat rigid frame sized and shaped to fit the outer perimeter of a particular light on the particular vehicle;
the mesh portion comprising a rigid mesh sized sufficiently small to prevent penetration of stones and road debris, but sufficient large to allow passage of light from the vehicle light;
the mesh portion being attached around a perimeter to of the light guard to the frame portion; the frame portion having at least one fastener to secure the light guard to the particular vehicle light; and
whereby, the mesh portion of the light guards cover each particular light protecting it from damage from stones and road debris.

11. The system of claim 10 wherein each mesh portion is stainless steel.

12. The system of claim 10 wherein each mesh portion comprises a diamond-shaped mesh pattern.

13. The system of claim 10 wherein each fastener comprises hook and loop material.

14. The system of claim 13 wherein each hook and loop material (Original) extends around the outer perimeter of each particular vehicle light.

15. The system of claim 10 wherein each light guard includes a plurality of fasteners.

16. The system of claim 10 wherein the frame portion, with the mesh portion attached, of each light guard has a thickness of approximately one-half inch.

17. The system of claim 10 further including light guards for each fog light.

18. A method of providing a light guard for a vehicle light, the vehicle light having an outer perimeter, the method consisting of:
providing a frame portion and a mesh portion, the frame portion comprising a flat rigid frame sized and shaped to fit the outer perimeter of a particular vehicle light;
the mesh portion comprising a rigid mesh sized sufficiently small to prevent penetration of stones:, and
road debris, but sufficient large to allow passage of light from the vehicle light; the mesh portion being attached around a perimeter of the light guard to the frame portion; and
whereby, the mesh portion of the light guards cover each particular light protecting it from damage from stones and road debris.

19. The method of claim 18 wherein each mesh portion is stainless steel.

20. The method of claim 18 wherein each fastener comprises hook and loop material.
